(19) United States
(12) Patent Application Publication
(10) Pub. No.: US 2005/0156758 A1
(43) Pub. Date: Jul. 21, 2005

(54) System and method for notifying operators of hazards

(76) Inventor: Samuel G. Gilliss, Parker, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/761,644

(22) Filed: Jan. 20, 2004

(51) Int. Cl. G08G 1/14

(52) U.S. Cl. 340/932.2; 340/933

(57) ABSTRACT

The present invention provides a hazard notification system for monitoring a vehicle travel zone. The system may include at least one monitoring device capable of detecting hazards in the vehicle travel zone, at least one notification device operable to receive information transmitted by the at least one monitoring device and present the information to a driver, and at least one activation device configured to enable operation of the system before a parked vehicle embarks through the vehicle travel zone. The system may detect hazards in the vehicle travel zone by operating an activation device, sending a signal from the activation device to a control device, enabling a monitoring device and a notification device, monitoring the vehicle travel zone, communicating vehicle travel zone information from the monitoring device to the notification device, and providing notification of vehicle travel zone information to a driver before embarking through the vehicle travel zone.

### INVENTIVE FIELD

The inventive field relates to systems and methods for notifying operators of vehicles, machinery and other devices of hazards. More particularly, the inventive field relates to systems and methods for visually notifying vehicle operators of hazards proximate to a given orientation, direction of travel and location of the vehicle.

### BACKGROUND

Although often equipped with rearview mirrors, large rear windows, back-up detection systems, video monitoring systems, direction of travel warning signals and indicators, and other warning and detection devices, operators of vehicles, machinery and other devices often are not provided with accurate and timely notification and warning of hazards proximate to a vehicle. Consequently, many accidents occur each year in garages, loading docks, construction yards and other locations which result in property damage, injuries, and deaths. Often such accidents occur because an operator of a vehicle is not timely notified of hazards behind, in front of and/or to the side the vehicle they are operating. Unintentional collisions with people, structures and/or objects often occur due to an operator's inability to see hazards proximate to the vehicle. The recent popularity of large vehicles, such as sport utility vehicles (SUV's) and minivans have exacerbated this problem.

Accordingly, there is need for a system and method for timely notifying operator's of vehicles of hazards proximate to a vehicle in a given location, orientation, and/or direction of travel.

### SUMMARY

One aspect of the present invention provides a hazard notification system for monitoring a vehicle travel zone. The hazard notification system comprises: at least one monitoring device capable of detecting hazards in the vehicle travel zone, at least one notification device operable to receive information transmitted by the at least one monitoring device and present the information to a driver, and at least one activation device configured to enable operation of the system before a parked vehicle embarks through the vehicle travel zone.

In another form, a hazard notification system for monitoring a vehicle travel zone comprises: at least one monitoring device configured to be connected with a first immobile object, at least one notification device configured to be connected with a second immobile object and operable to receive information transmitted by the at least one monitoring device, at least one control device operable to supply power to the at least one monitoring device and the at least one notification device, and at least one activation device configured to communicate with the at least one control device to enable operation of the at least one monitoring device and the at least notification device before a vehicle embarks through the vehicle travel zone.

In yet another form, the present invention provides a method for detecting hazards in a vehicle travel zone. The method comprises the steps of: operating an activation device, sending a signal from the activation device to a control device, enabling a monitoring device and a notification device, monitoring the vehicle travel zone, communicating vehicle travel zone information from the monitoring device to the notification device; and providing notification of the vehicle travel zone information to a driver before embarking through the vehicle travel zone.

The features, utilities, and advantages of various embodiments of the invention will be apparent from the following more particular description of embodiments of the invention as illustrated in the accompanying drawings and defined in the appended claims.

### BRIEF DESCRIPTION OF THE DRAWINGS

FIGS. 1A-1C are schematic representations of a first system embodiment of the present invention.

FIG. 2 is a flow diagram of a first method for notifying drivers of hazards using one embodiment of the present invention.

FIG. 3 is a flow diagram of a second method for notifying drivers of hazards using one embodiment of the present invention.

FIG. 4 is a flow diagram of a third method for notifying drivers of hazards using one embodiment of the present invention.

FIG. 5 is a schematic representation of a system embodiment utilizing a transceiver as a control device.

FIG. 6 is a top view showing a first embodiment of a system of the present invention installed in a garage.

FIG. 7 is a view of a monitoring device mounted on a front left wall of the garage as used in one embodiment of the present invention.

FIG. 8 is a side view of an embodiment of the invention installed in the garage utilizing a flexible arm to suspend a notification device.

FIG. 9 is a side view of an embodiment the invention installed in the garage utilizing the flexible arm and a telescoping pole to suspend the notification device.

FIG. 10 is an embodiment of the invention utilizing a multi-component configuration.

FIG. 11 is a wiring diagram according to an embodiment of the invention.

### DETAILED DESCRIPTION

The various embodiments of the present invention provide a system and method for notifying vehicle operators of hazards with respect to a given orientation, location and/or direction of travel of a vehicle. In one embodiment, the present invention may be utilized to monitor a vehicle travel zone (“VTZ”), such as a garage and attached driveway, and to assist an operator of a vehicle in detecting hazards within the VTZ. It is to be appreciated that the VTZ may be a flat surface, such as a driveway, or a volume of space, such as a cubic or other area within a garage or other location having three dimensions. The system is configured to provide, to an operator or other person associated with the operation and/or control of a vehicle (hereinafter, a “driver”), notification of hazards within the VTZ that are proximate to the vehicle. Such notification ideally includes a visual representation of hazards and/or other conditions within the VTZ. Further, such notification is desirably provided to the driver prior to the vehicle entering and/or traveling within the VTZ.

Further, one embodiment of the present invention may provide for automatic activation and/or deactivation of the notification system. Such activation or deactivation may occur prior to, during and/or after the driver and/or the vehicle is in or out of the VTZ. Further, such activation or deactivation may be pre-programmed, customized, fixed, pre-determined or otherwise specified to occur upon the activation of certain actions or events. Such certain actions may include, but are not limited to, the driver entering or exiting the vehicle, operation of the vehicle, the vehicle traveling on, through, above, below or within the VTZ, based upon pre-determined time settings or a passing of time, a detection of moving objects within the VTZ, a detection of non-moving hazards within the VTZ and/or other actions or events.

Although various embodiments of the invention described herein depict the invention as applied to an automobile parked in a garage with an adjacent driveway, the invention may be utilized in other parking areas, such as parking lots, car ports, and loading docks. The invention may also be utilized with other vehicles and locations, such as airplanes at airports, boats in marinas, and trains in railroad yards.

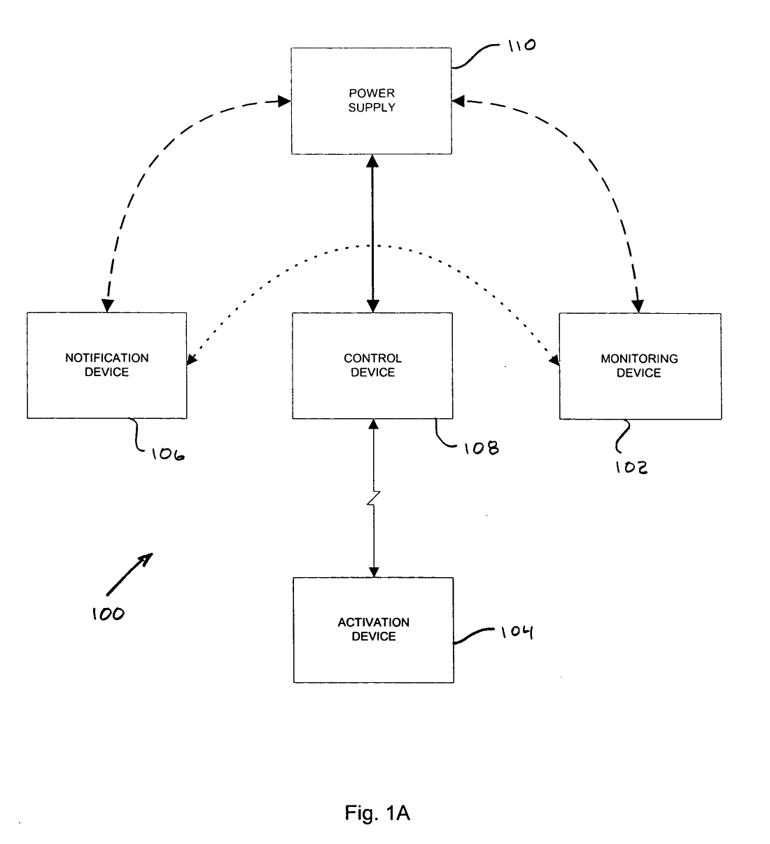

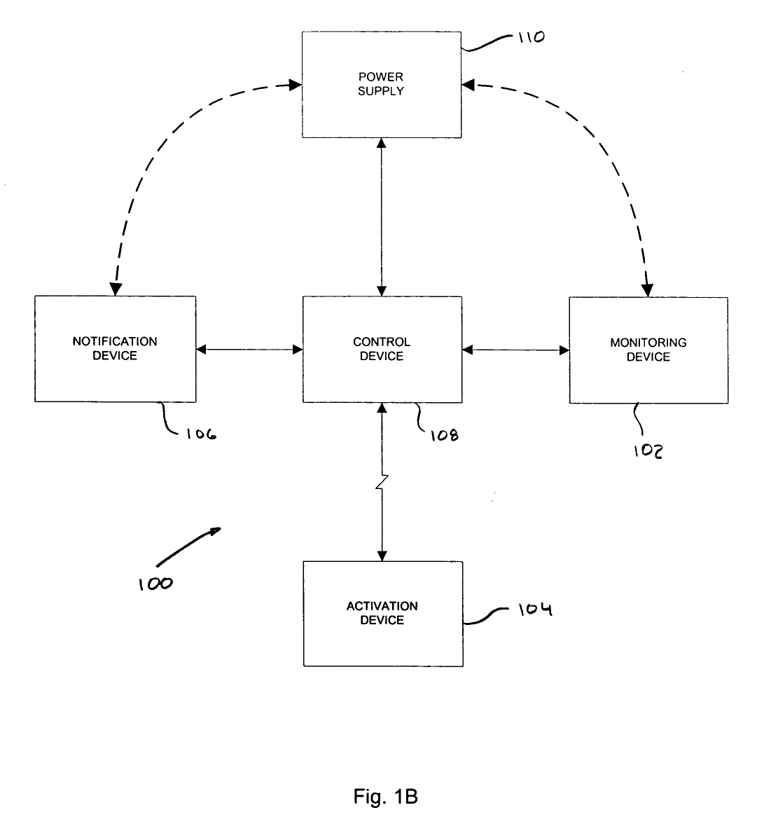

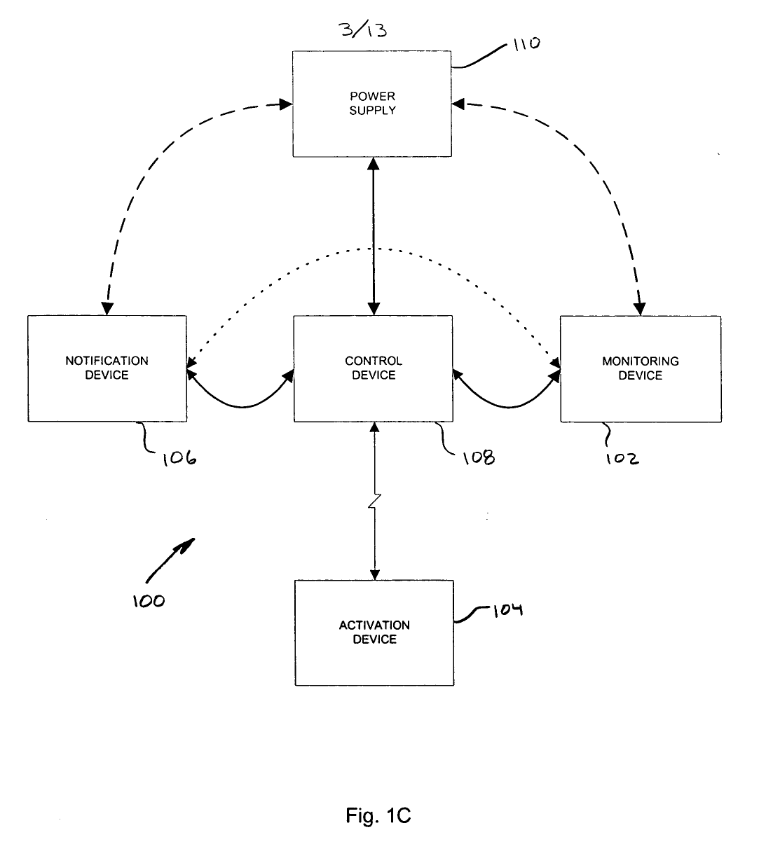

FIGS. 1A-1C are schematic diagrams showing the various components which may be utilized in a system 100 for notifying operators of hazards in a VTZ. The system 100 may include: one or more monitoring devices 102, such as a camera, a video detection device and/or a motion sensing device; one or more activation devices 104, such as a key pad, a pressure sensor, and/or a motion sensor; one or more notification devices 106, such as a video display device, and an audio device; one or more control devices 108, such as a transceiver; and one or more power supply devices 110.

It is to be appreciated that any given combination of notification, control, activation, and power devices may be used in the various embodiments and for implementation of the present invention. As shown in FIGS. 1A-1C, the power supply 110 may act to provide power to the monitoring device 102 and the notification device 106. In other embodiments, the power supply 110 may also provide power to the control device 108 and the activation device 104. As discussed in more detail below, the activation device 104 may provide signals that cause the system to activate and/or deactivate, and the control device 108 may act to enable and/or disable the monitoring device 102 and the notification device 106 based on signals received from the activation device 104. The monitoring device 102 surveys the VTZ for hazards and provides information relating to hazards in the VTZ to the notification device 106. In turn, the notification device 106 provides notification of hazards in the VTZ to the driver.

The system 100 may be arranged to utilize hard-wired communication or wireless communication, such as by sending and receiving radio frequency (RF) signals, or a combination thereof to transfer signals between the various system components. The components may also be configured in various communication arrangements to provide a system that notifies drivers of hazards in the VTZ, as shown in FIGS. 1A-1C. For example, as shown in FIG. 1A, the system components may be arranged such that the monitoring device 102 and the notification device 106 communicate directly with each other, and the control device 108 communicates with the power supply and the activation device. The power supply 110 may be configured to provide power to the monitoring device 102 and the notification device 106. In such an embodiment, the control device 108 may indirectly control the features, function, and/or operation of the notification device 106 and/or the monitoring device 102 by enabling, disabling, and/or controlling power provided by the power supply 110. Further, human or automated interface with the controller may be provided through the activation device 104, which, in turn may communicate activation signals to the control device 108. The system 100 may also be configured such that the control device 108 may disable the system automatically based on the satisfaction of some condition or event, such as the expiration of time on a deactivation timer.

In another configuration shown in FIG. 1B, the system components may be arranged such that the monitoring device 102 and the notification device 106 do not communicate directly with each other, but, instead communicate through the control device 108. In such an embodiment, the control device 108 may directly control the features, function, and/or operation of the notification device 106 and/or the monitoring device. The control device may also indirectly control the features, function, and/or operation of the notification device 106 and/or the monitoring device through the power supply 110, as discussed above with reference to FIG. 1A. The activation device 104 may also interface the control device 108 in the same manner as described above with reference to FIG. 1A.

In yet another configuration, shown in FIG. 1C, the activation device 104, the monitoring device 102, the notification device 106, and the power supply 110 may all be in communication with the control device 108. The monitoring device 102 may also be configured to communicate directly with the notification device 106. In yet another embodiment, it is to be appreciated the control device 108 may not be integrated at all. In such an embodiment, the system 100 may be configured so that the activation device 104 interacts directly with the power supply 110 and/or the monitoring device 102 and notification device 106.

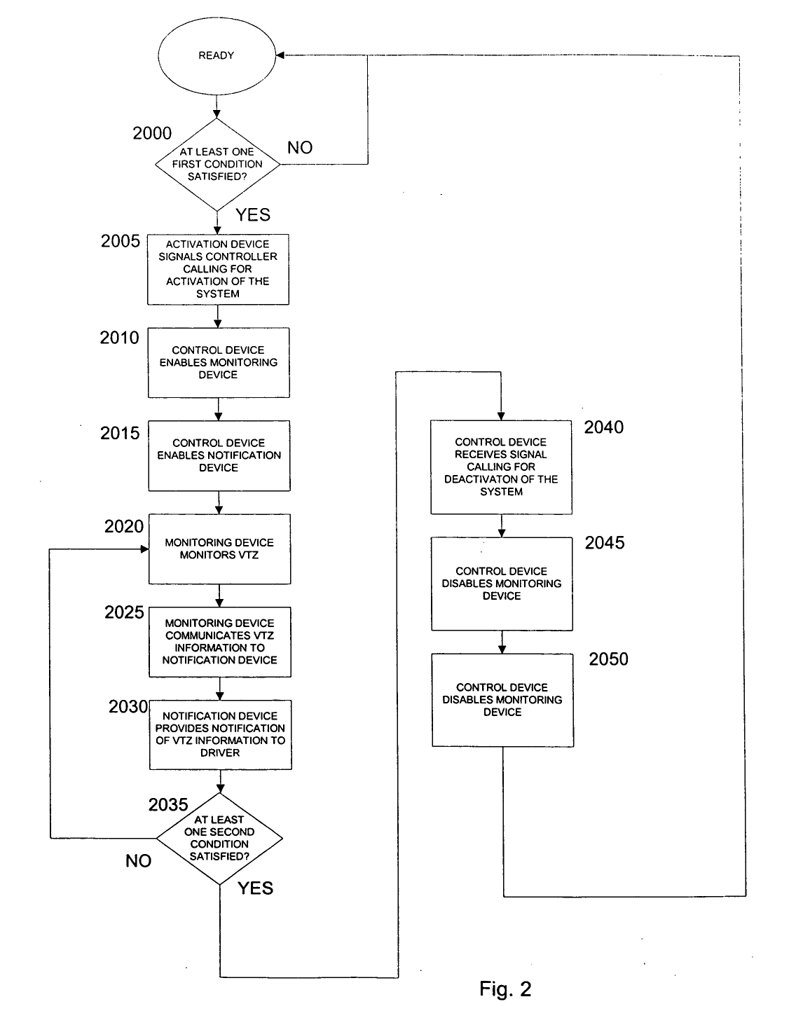

The system 100, described with reference to FIGS. 1A-1C, may be used to detect hazards in the VTZ according to the methods depicted in FIGS. 2-4. As shown in FIG. 2, from a state of readiness and upon the satisfaction of at least one first condition (operation 2000), such as motion detected by a motion sensor or key pad entry, the activation device provides a signal to the control device calling for the control device to activate the system (operation 2005). Upon receipt of the signal from the activation device, the control device sends at least one signal to enable the monitoring device and notification device (operations 2010 and 2015). In the embodiment shown in FIG. 1A, the control device 108 may activate the system 100 by enabling the power supply 110 to provide power the monitoring device 102 and the notification device 106. In the embodiments shown in FIGS. 1B and 1C, the control device 108 may act to directly enable the monitoring device 102 and the notification device 106. As such, direct or indirect control of system components may be provided by the various embodiments of the present invention. Once enabled, the monitoring device acts to monitor the VTZ (operation 2020). Information from the VTZ gathered by the monitoring device and/or information reflecting the condition and/or configuration of fixed and/or movable objects within the VTZ may be communicated to the notification device (operation 2025), which provides notification to the driver of information from the VTZ gathered by the monitoring device (operation 2030). In the embodiments shown in FIGS. 1A and 1C, the monitoring device 102 may communicate directly with the notification device 106. In the embodiments shown in FIGS. 1B and 1C, the monitoring device 102 may communicate with the notification device 106 through the control device 108. Upon the satisfaction of at least one second condition (operation 2035), such as a completion of a deactivation timer or upon receipt of a signal from the activation device, the control device receives a signal calling for the deactivation of the system (operation 2040). Upon receipt of the deactivation signal, the control device sends at least one signal to disable the notification device and the monitoring device (operations 2045 and 2050), and returns the system to the state of readiness. The order in which the operations shown in FIG. 2 are performed may vary, and should not be construed to be limited the order depicted.

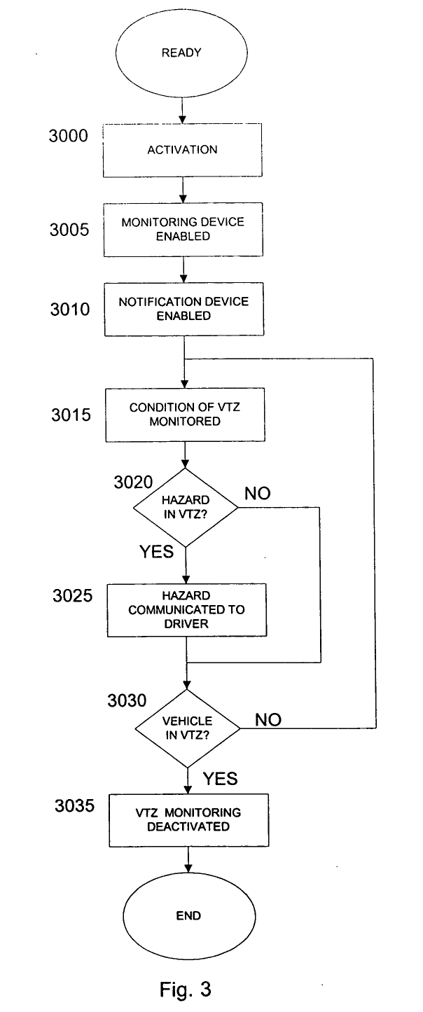

An alternative method for detecting hazards in the VTZ is depicted in FIG. 3. From a state of readiness and upon activation (operation 3000), such as motion detected by a motion sensor or key pad entry, the monitoring device and notification device are enabled (operations 3005 and 3010). After enabling the monitoring device and the notification device, the condition of the VTZ is monitored (operation 3015). If no hazard is detected in the VTZ (operation 3020), the system then determines whether the vehicle is in the VTZ (operation 3030). If a hazard is detected within the VTZ (operation 3020), the hazard information is communicated to the driver (operation 3025) before the monitoring device determines if the vehicle is in the VTZ (operation 3030). If monitoring device does not detect the vehicle in the VTZ, the system continues to monitor the condition of the VTZ (operation 3015). If the monitoring device detects the vehicle in the VTZ, monitoring of the VTZ is deactivated. The order in which the operations shown in FIG. 3 are performed may vary, and should not be construed to be limited the order depicted.

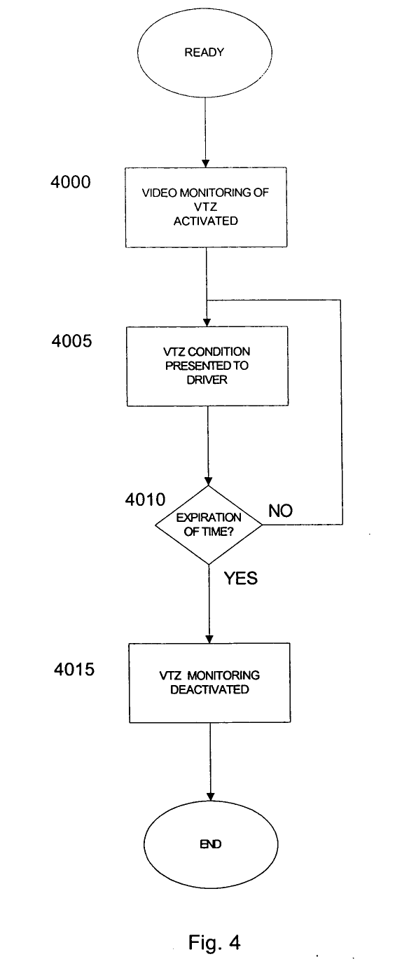

Another alternative method for detecting hazards in the VTZ is depicted in FIG. 4. The system utilizing the method shown in FIG. 4 may include a video monitoring device as the monitoring device and a video monitor as the notification device. As shown in FIG. 4, from a state of readiness, video monitoring of the VTZ is activated (operation 4000). As previously discussed, activation may occur in various was, such as based on a signal from the activation device. The VTZ condition is then presented to the driver (operation 4005). The condition of the VTZ is continually presented to the driver until the expiration of a period of time (operation 4010). Once the period of time has expired, monitoring of the VTZ is deactivated (operation 4015). The order in which the operations shown in FIG. 4 are performed may vary, and should not be construed to be limited the order depicted.

In one embodiment, the system 100 may be configured so the that power supply 110 provides power to the notification device 106 and the monitoring device 102. In other embodiments, the power supply may also supply power to the activation device and control device. Depending on the power requirements of the system components, the power supply may be alternating current (AC) electricity available from a standard wall outlet, such as 120 VAC or 220 VAC. In other embodiments, some or all of the system components may require direct current (DC) power. In one embodiment, the notification device and the monitoring device each require 12 VDC electricity for operation. In such a configuration, the power supply includes a DC transformer/rectifier module to convert AC electricity from the wall outlet to DC power. An exemplary embodiment of the invention may be configured to use Model #2792-10 available through 123 CCTVM (123 CCTV Security Camera Surveillance, 8156H S. Wadsworth Blvd. Littleton, Colo. 80128), which is capable of providing 1.0 amp current at 12 VDC. However, other power supplies and/or voltages and currents may be used as necessary. It should also be noted that the system may be configured to be completely wireless, and in such a configuration, the monitoring device 102, the notification device 106, and the activation device 104 may each have their own self contained power supplies, such as batteries.

The activation device 104 may provide signals directing, instructing, or causing the activation and/or deactivation of the system. Many different types of activation devices may be utilized with the present invention, alone or in combination with one another, and may be manually or automatically operated. For example, some embodiments of the present invention may utilize a pressure sensitive floor mat located near the vehicle as the activation device. In such a configuration, the activation device may provide an activation signal to the system when the driver of the vehicle steps on the floor mat while entering the vehicle. Other embodiments may utilize a motion sensor as the activation device. In such a configuration, the activation device may send the activation signal when the driver of the vehicle passes by the motion sensor while entering the vehicle or as the vehicle and/or other objects move into the VTZ under certain conditions (for example, within a given time frame or event, such as a garage door opening). Other embodiments may utilize the pressure sensitive floor mat in combination with the motion sensor as the activation device. In another embodiment, the engagement of reverse drive in the vehicle acts as the activation device. Other examples of activation devices for the present invention include a garage door button, limit switches on a garage door, detection of motion in the VTZ, manual key pad entry and the like. It should also be noted that the activation device may also be used to operate other devices, such as lighting for the VTZ, garage doors, security systems, and the like.

In an exemplary embodiment, the system 100 utilizes a motion sensor placed near the vehicle as the activation device. The motion sensor may include an outer shell housing a sensor lens and batteries (if required) with associated electronics. Some motion sensors are configured to sense infrared energy in a field of view through the sensor lens. The motion sensor may be configured to cause system activation when the motion sensor detects rapid changes in infrared energy, such as when a person passes through the field of view while entering the vehicle or upon ignition of a vehicle and the production of hot exhaust gases from the vehicle. Many different types of motion sensors may be utilized with the present invention, such as those utilizing photosensors, radio energy, radar, and sound waves. One type of motion sensor used with one embodiment of the invention is Model #MS14A, available through X10 Wireless Technologies, Inc.® (19823 58th Place SouthKent, Wash. 98032). In certain configurations, it may be advantageous to limit the field of view of the motion sensor to prevent inadvertent activation of the system by people or animals other than the driver entering the vehicle.

The monitoring device 102 acts to survey the VTZ and provide information relating to hazards in the VTZ to be received by the notification device. The system 100 may utilize various types of monitoring devices, such as cameras and motion sensing devices, alone or in combination. The monitoring devices may be secured to a fixed object, such as a structure near the VTZ, or may also be mounted on the vehicle. The monitoring devices may also be mounted on both the vehicle and a fixed object. For example, one embodiment of the system may utilize a camera as the monitoring device secured to a fixed object to capture and provide images of the VTZ to the notification device. In another embodiment, the camera may be mounted on the vehicle. In yet another embodiment, the system utilizes a fixedly mounted camera in combination with a motion sensor mounted on the vehicle as the monitoring devices. In such a configuration, the notification device may include a video monitor and an audio alarm, where the camera provides images of the VTZ for display on the video monitor and the motion sensor provides a trigger for the audio alarm to alert the driver of hazards in the VTZ. In other embodiments, the notification device may use a combination of motion sensors and video cameras to provide an alarm presentation, such as a message displayed on a screen.

Systems that utilize cameras as the monitoring devices may be configured as a closed circuit television system (CCTV) that utilizes a black and white charged-coupled device (CCD) camera with a low light sensitivity of 0.01 Lux, such as Model #2505-BCAM available through 123 CCTV™. Other types of cameras may also be used, such a those that employ complementary metal-oxide technology (CMOS). Although some embodiments of the present invention utilize black and white cameras, other embodiments of the present invention may utilize color cameras. The camera may also include various types of lenses depending upon the application. For example, some cameras are supplied with a standard 3.6 mm lens, which typically provides a 90° field of view. However, an exemplary camera embodiment utilizes a 2.5 mm wide angle fish-eye lens with a 120° field of view, such as Model #2775-LM2.5 available through 123 CCTV™. The camera may also include a zoom lens capable of remote adjustment by the user. In addition, the camera may utilize infrared technology for low light situations. Other types of cameras and configurations that may be used with the present invention include the use of digital technologies, optical technologies, and technology used with pinhole type cameras.

Various types of notification devices 102 may be used with the system 100 to provide the driver of the vehicle notice of hazards in the VTZ. For example, the notification device may be an auditory alarm, a flashing light, a video display, or any combination thereof. Another embodiment of the present invention does not utilize a video display, instead, the images captured by the monitoring device are projected onto an object in front of the vehicle, such as the rear wall of a garage. The notification devices may be secured to a fixed object, such as a structure near the vehicle, and may also be mounted on the vehicle. Notification devices may also be mounted on both the vehicle and a fixed object. For example, one embodiment of the system may utilize a video display installed on a fixed object near the vehicle within the view of the driver. The video display receives and displays images of the VTZ from the monitoring device. The system may be configured to activate the video display so the driver may observe any hazards present in the VTZ before the driver moves the vehicle into, through or out of the VTZ. In another embodiment, the driver may be provided with an auditory alarm or flashing light triggered by a motion sensor in combination with a video display to provide notification of hazards in the VTZ.

Embodiments of the invention may utilize various types of video displays as the notification device 106. For example, one embodiment of the invention utilizes a 5.7 inch liquid crystal display (LCD) monitor, such as Model #570-M-3 available through Xenarc Technologies™ (2750 S. Harbor Blvd, Unit E Santa Ana, Calif. 92704). In addition, the system may also utilize different types of signals, such as National Television System Committee (NTSC), phase alternation by line (PAL), System Electronique Couleur Avec Memoire (SECAM), S-Video and other video systems known in the art.

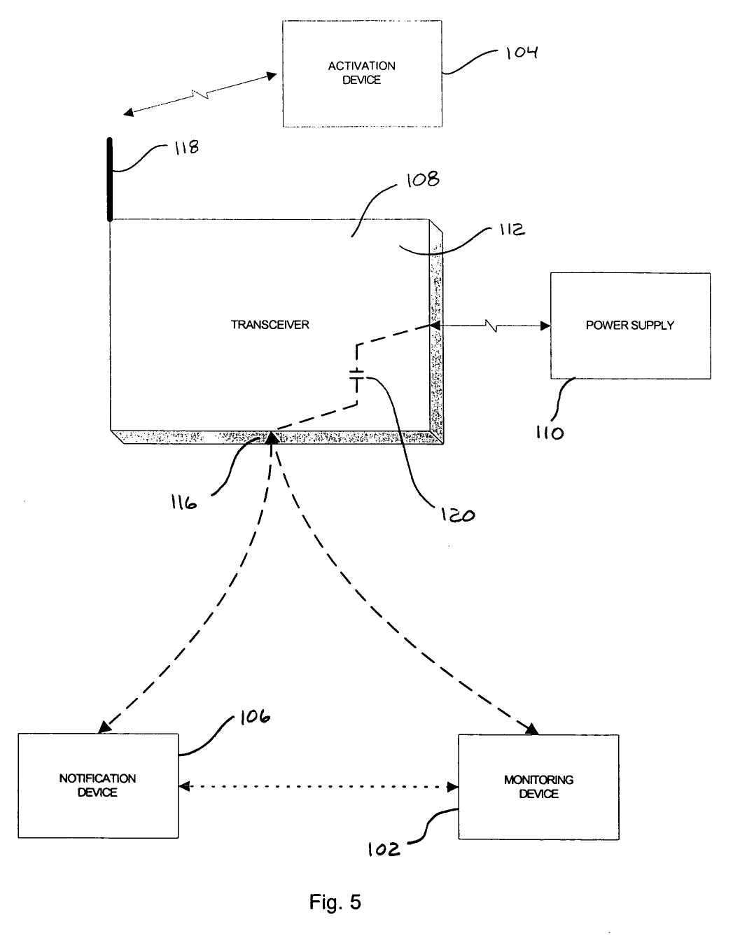

In embodiments of the invention having the control device 108, the control device receives signals from the activation device 104 and acts to enable and/or disable the system 100 through communication with the power supply 110 and/or notification and monitoring devices. FIG. 5 shows a schematic representation of an embodiment of the invention utilizing a transceiver 112 as the control device. The transceiver 112 may include a power input connection 114, a power output connection 116, an antenna 118, a switch 120, a deactivation timer (not shown), and associated electronics (not shown). In the system depicted in FIG. 5, the activation device 104 is in wireless communication with the transceiver 112. In other embodiments, the activation device 104 may be hardwired to the transceiver 112. The power supply 110 is connected with the power input connection 114 on the transceiver 112, and the notification device 106 and the monitoring device 102 may be both be connected with the power output connection 116. Based on signals received from the activation device 104, the transceiver 112 may act to operate the switch 120, thereby allowing current to pass from the power input connection 114 to the power output connection 116. The antenna 118 acts to lengthen the distance over which the transceiver 112 may receive signals from the activation device 104. The deactivation timer acts to open the switch 120 after a preselected period of time, which in turn cuts the power to the notification device 106 and the monitoring device 102. Some embodiments of the transceiver 112 allow the user to adjust the deactivation timer. Depending upon the specific application, the deactivation timer requirements may vary. For example, in one embodiment of the present invention, the deactivation timer is set to 8 minutes. Various types of transceivers may be used with the present invention, such as Model #TM751 available through X10 Wireless Technologies, Inc.® In some embodiments of the present invention, power may be delivered directly to the system from the power output connection 116, and in other configurations, the power from the power output connection 116 may be first fed to a transformer and/or rectifier before passing onto the system.

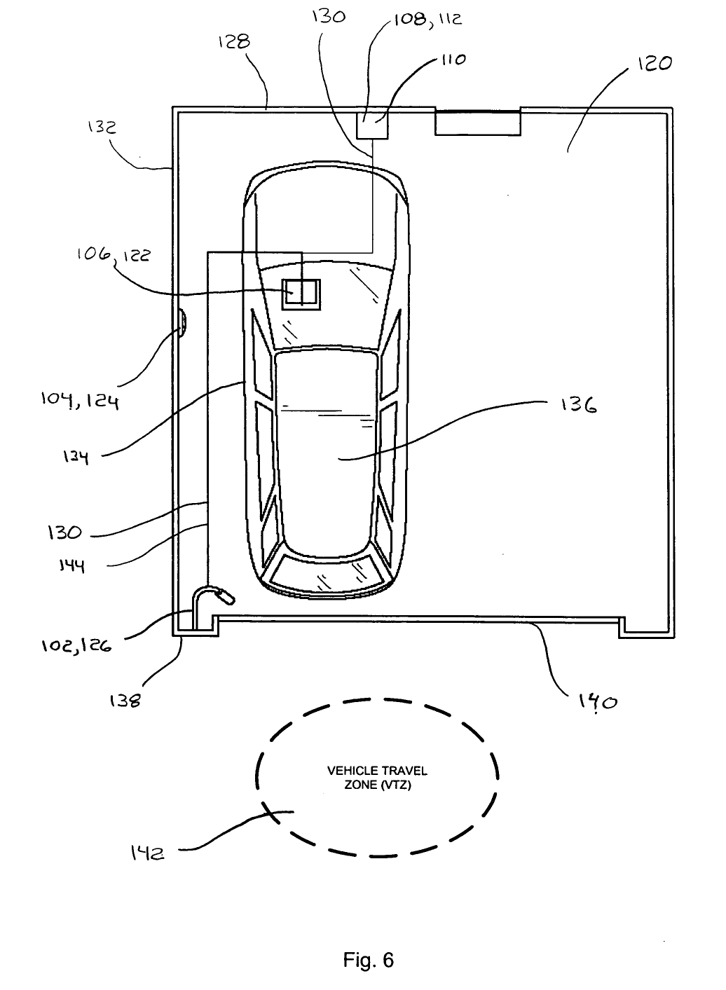

FIGS. 6, 8, and 9 provide embodiments of the present invention wherein the system is utilized in a garage 120. The system shown in FIG. 6 includes a transceiver 112 used as the control device 108; a video display 122 used as the notification device 106, a motion sensor 124 used as the activation device 104, and a camera 126 used as the monitoring device 102. As viewed from above the garage 120, the transceiver 112 may be mounted, for example, with the power supply 110 on a front wall 128 of the garage 120, preferably near an electrical outlet. In other embodiments, the control device may be mounted on other walls or on a ceiling of the garage. In the embodiment shown in FIG. 6, the transceiver 112 may operate the power supply 110, which provides power to the camera 126 and the video display 122 via a power cable 130. As previously mentioned, the power supply 110 and transceiver 112 may be configured to convert electricity from the wall outlet, such as 120 VAC, to another form, such as 12 VDC.

As shown in FIG. 6, the motion sensor 124 may be mounted, for example, on a left wall 132 near a driver's side door 134 of a vehicle 136 parked in the garage 120. The motion sensor 124 ideally is in wireless communication with the transceiver 112 and may be used to activate the transceiver to supply power to the camera 126 and display device 122. The camera 126 is mounted, for example, on a front left wall 138 near a garage door opening 140 and is aimed toward a VTZ 142 represented by an elliptical shape shown in dashed lines. It is to be appreciated that the VTZ may include any area both inside and/or outside the garage. In the embodiment shown in FIG. 6, the VTZ 142 may include a three-dimensional area above a section of the driveway located to the rear of the vehicle 136. The video display 122, which is connected to the camera 126 via a video cable 144, is suspended from a garage ceiling 146 and is positioned in front of the driver when the driver is seated in a driver's seat of the vehicle. When the transceiver operates the power supply to provide power to the camera and display device, the images captured by the camera are presented to the driver via the display device.

The system shown in FIG. 6 may be configured to operate in accordance with the methodology previously described with reference to FIGS. 2-4. When in a state of readiness, the power supply 110 in FIG. 6 is not supplying power to the video display 122 and the camera 126. When the motion sensor 124 detects movement, such as from the driver entering the vehicle 136, the motion sensor 124 signals the transceiver 112 to enable the video display 122 and the camera 126, along with a deactivation timer. The transceiver 112 acts to allow the power supply 110 to provide power to the camera 126 and the video display 122. The camera 126 relays images of the VTZ 142 to the video display 122, which in the embodiment shown in FIG. 6 is located in front of the vehicle 136. As such, the driver has an unobstructed view of the VTZ 142 before backing up the vehicle 136. Once the driver is satisfied that no hazards exist in the VTZ 142 behind his vehicle, he may back the vehicle 136 out of the garage 120. After a preselected period of time, the automatic deactivation timer causes the transceiver 112 to disable the camera 126 and video display 122. The system remains in a ready state until the transceiver 112 receives another signal from the motion sensor 124.

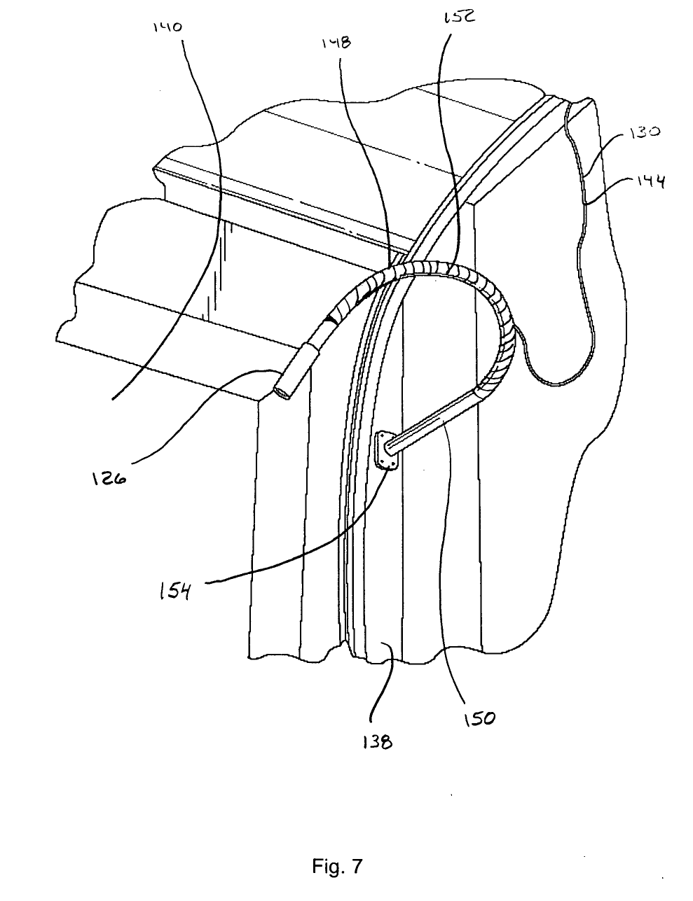

FIG. 6 shows the camera 126 mounted near the garage door opening 140, and FIG. 7 shows a more detailed view of the camera 126 mounted on the front left wall 138. As shown in FIG. 7, the camera 126 may be connected with a flexible arm 148 that allows the user to easily aim the camera 126 in a plurality of directions. In the embodiment shown in FIG. 7, the flexible arm 148 is defined by a rigid portion 150 connected with a flexible portion 152. The camera is connected with the flexible portion 152, and the rigid portion 150 of the flexible arm 148 is connected with a base plate 154. The base plate is connected with the front wall 138 of the garage 120 and may be held in place by screws or other means, such as adhesive. Various types of flexible arms may be used with the invention, such as Model #1675-01 available through Moffatt Products, Inc (222 Cessna Street Watertown, S. Dak. 57201), which is defined by a 7 inch rigid portion and a 18 inch flexible portion.

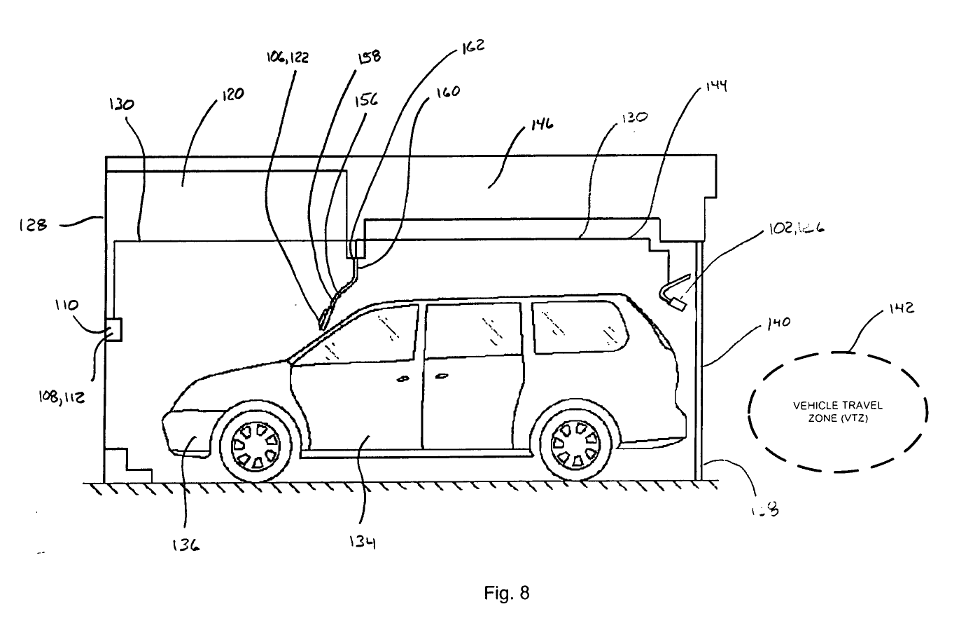

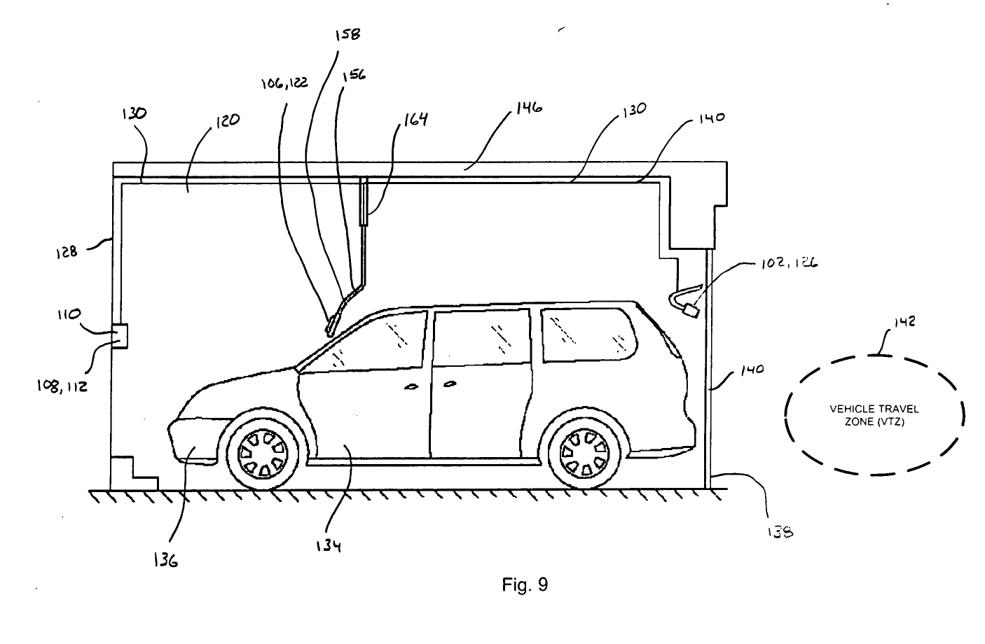

As shown in FIGS. 8 and 9, once the camera 126 and flexible arm 148 are mounted on the wall 138, a user may then bend the flexible arm 148 as necessary, and in one embodiment approximately 180° and slightly downward, to aim the camera 126 toward the VTZ 142 to be monitored. In one embodiment, the camera 126 is mounted at a height of 6 feet or more above the ground in order to give a “top-down” view of the VTZ. Although the camera may be mounted inside the garage, the camera may also be mounted in other locations as well. For example, the camera may be mounted outside of the garage. In other embodiments, the camera may be mounted on the door jam of the garage or in the center of the garage. In addition, the camera need not be mounted on a flexible arm. For example, the camera may be connected directly with the wall, mounted on a rigid arm, or mounted on a rigid arm utilizing a ball and socket arrangement to allow for movement of the camera.

As shown in FIG. 6, the notification device 106 or video display 122 may be placed in front of the vehicle 136, so it is more likely the driver will pay attention to what is displayed on the display device 122 before backing the vehicle out of the garage. Placement of the notification device 106 outside the vehicle 136 also allows the invention to work with any vehicle as opposed to only vehicles equipped with a notification device that is operable with the system. In addition, locating the notification device 106 in front of the vehicle 136 acts as a parking aid to assist the driver when attempting to park the vehicle at an appropriate or desired location inside the garage 120. Although the notification device 106 may be placed in a position in front of the vehicle, the location and mounting of the notification device 106 is not limited to that which is depicted herein. For example, the notification device may be located on the wall to one side of the vehicle, or inside the vehicle, such as on a sun visor or on a rear view mirror.

As shown in FIG. 8, the notification device 106 may be mounted on a flexible member 156 connected with the garage ceiling 146 in order to place it in front of the driver of the vehicle when parked in the garage. The flexible member 156 enables the user, as desired, to place the notification device 106 in front of the driver at a distance and tilt from the vehicle 136 to allow for optimum viewing. The flexible member 156 shown in FIG. 6 may include a rigid tube 158 connected with a flexible tube 160. The notification device 106 may be connected to the flexible tube 158, and the rigid tube 160 of the flexible member 156 may be connected to a base portion 162, or vice versa. The base portion 162 may be fastened to the ceiling 146 of the garage and may be held in place by screws or other means, such as adhesive. Various lengths and types of flexible members may be used. For example, one embodiment of the present invention utilizes a 24 inch flexible arm, such as Model #1675-02 available through Moffatt Products, Inc., connected with a 4 inch rigid tube, such as Model #1675-03 available through Moffatt Products, Inc.

Sometimes the garage ceiling 146 from which a notification device 106 depends may require additional lengths to be added to the flexible member 156. In order to provide additional notification device positioning options, some embodiments of the present invention may utilize a telescoping pole 164 connected between the ceiling 146 and the flexible member 156, as shown in FIG. 9. Various types of telescoping poles may be used. For example, the telescoping pole utilized in one embodiment has two sections with an internal cam arrangement and is capable of extending to a length of 5 feet. Other lengths and configurations of the of the flexible member 156 may also be used in conjunction with the present invention.

Although the notification device 106 may be mounted on the flexible member 156 inside the garage 120, the notification device need not be mounted on the flexible member. For example, the notification device 106 may be mounted on a rigid member, or mounted on a rigid member utilizing a ball and socket arrangement to allow additional positioning options for the notification device. Other embodiments of the present invention may utilize a swivel arm-joint connected with the telescoping tube that allows the user to conveniently and temporarily move the notification device in the event the notification device would otherwise interfere with some activity, such as cleaning the garage. The notification device may also be affixed to the garage through a track arrangement that also allows for easy manipulation of the monitor location, in both side-to-side and back-and-forth directions. Other embodiments may utilize an automatic tracking system the actually moves the notification device along with the vehicle as the vehicle backs out of the garage. Still other embodiments may utilize an automatic extension arm that extends or retracts when the system is activated or deactivated.

It should also be noted that embodiments of the invention utilizing motion sensors as the activation device do not require placement of the motion sensor on the wall near the driver's side door of the vehicle. Because the activation device may be configured to be in wireless communication with the control device or power supply, the motion sensor may be placed inside the vehicle. In an embodiment of the invention configured with the motion sensor located inside the vehicle, the system deactivation timer may be eliminated, because the system will automatically shutdown when the motion detector is moved outside the distance from where the control device or power supply is capable of receiving the signal from the motion sensor.

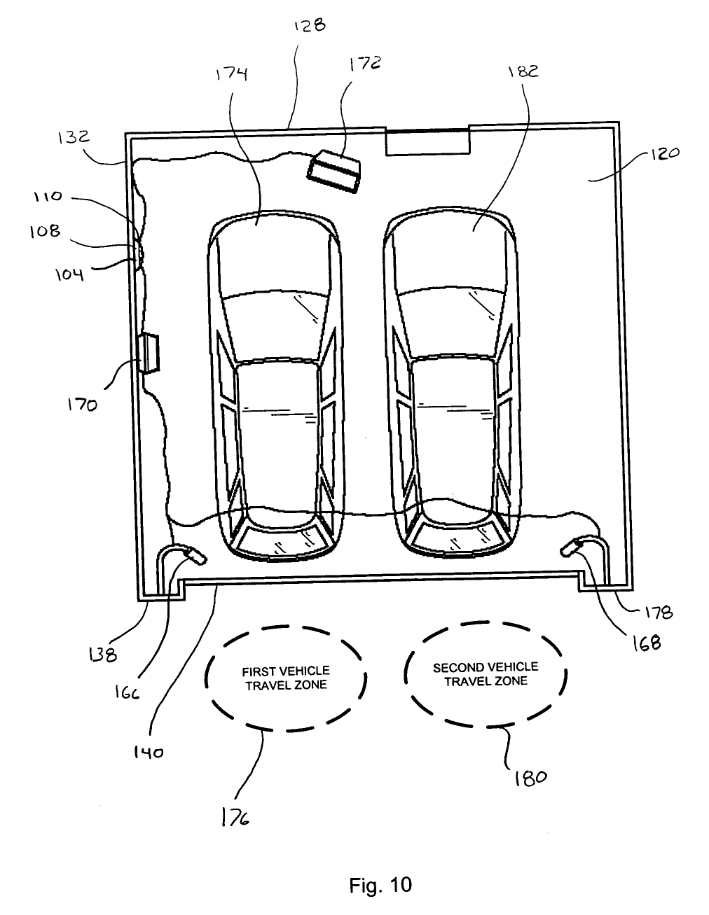

As described above, the available components of the invention described above may be combined to interact in various ways in order to provide an effective system to aid the driver of the vehicle in detecting hazards in a VTZ. For example, some embodiments of the invention utilize more than one of each of the available components. FIG. 10 shows the system installed in the garage having a first monitoring device 166, a second monitoring device 168, a first notification device 170, a second notification device 172 hardwired together with the activation device 104, control device 108, and power supply 110. As viewed from above the garage 120, the activation device 104 is mounted on the left wall 132 near the left-front side of a first vehicle 174. The first monitoring device 166 is mounted on the front left wall 138 near the garage opening door 140 and is directed toward a first VTZ 176 behind the first vehicle 174. The second monitoring device 168 is mounted on a front right wall 178 near the garage door opening 140 and is directed toward a second VTZ 180 behind a second vehicle 182. The first notification device 170 is mounted on the left wall 132 and is positioned to the left of the first vehicle 174. The second notification device 172 is mounted on the front wall 128 and is positioned to the right front of the first vehicle 174 and to the left front of the second vehicle 182. When the system is activated, information captured by the first monitoring device 166 may be communicated to the first notification device 170 and information captured by the second monitoring device 168 may be communicated to the second notification device 172. The embodiment shown in FIG. 10 may also be configured so the information captured by both monitoring devices is communicated to either notification device.

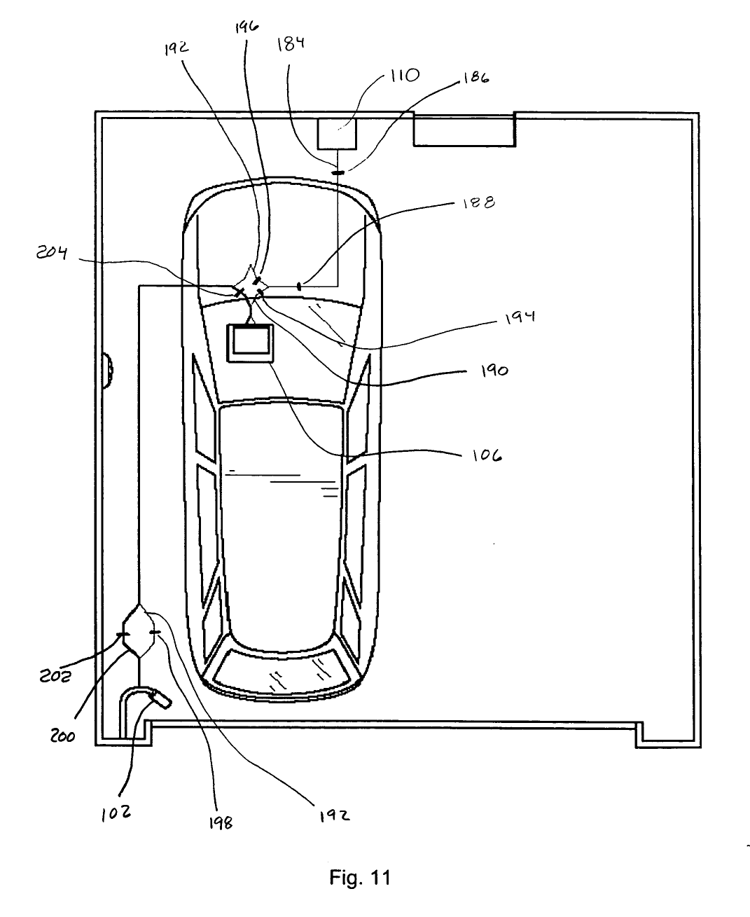

As well as utilizing different components in different configurations, embodiments of the invention utilizing hardwired connections between components may be wired in various ways. For example, FIG. 11 shows one embodiment of a wiring configuration. A first power cable 184 extends from the power supply 110 to a first connection point 186. From the first connection point 186, the first power cable 184 extends to a second connection point 188. The first power cable 184 then extends from the second connection point 188 and branches into second 190 and third 192 power cables extending to third 194 and fourth 194 connection points, respectively. From the third connection point 194, the second power cable 190 extends to and connects with the notification device 106. From the fourth connection point 196, the third power cable 192 extends to a fifth connection point 198 before connecting with the monitoring device 102. From the monitoring device 102, a video cable 200 extends to a first video connection point 202 and then to a second video connection point 204 before extending to and connecting with the notification device 106. The connection points may also be configured to allow for easy connection and disconnection of system components.

Although various embodiments of this invention have been described above with a certain degree of particularity or with reference to one or more individual embodiments, those skilled in the art could make numerous alterations to those disclosed embodiments without departing from the spirit or scope of this invention. For example, although one embodiment of the present invention as described above depict the invention as applied to a vehicle parked in a garage, it is to be appreciated that the invention may also be applied to other locations, such as a loading dock. In such an embodiment, dock monitoring devices may send signals to dock notification devices located near the loading dock. It is also intended that all matter contained in the above description and shown in the accompanying drawings shall be interpreted as illustrative only of particular embodiments, and not limiting. Changes in detail or structure may be made without departing from the basic elements of the invention as defined in the following claims.

1. A hazard notification system for monitoring a vehicle travel zone comprising:
at least one monitoring device capable of detecting hazards in the vehicle travel zone;
at least one notification device operable to receive information transmitted by said at least one monitoring device and present said information to a driver; and
at least one activation device configured to enable operation of the system before a parked vehicle embarks through the vehicle travel zone.

2. The hazard notification system of claim 1, wherein said at least one monitoring device is configured to be connected with a first immobile object.

3. The hazard notification system of claim 2, wherein said at least one notification device is configured to be connected with a second immobile object.

4. The hazard notification system of claim 2, wherein said at least one notification device is configured to be connected inside a vehicle.

5. The hazard notification system of claim 1, wherein said at least one activation device is a motion detector.

6. The hazard notification system of claim 1, wherein said at least one notification device is a video display device.

7. The hazard notification system of claim 1, wherein said at least one monitoring device is a camera.

8. The hazard notification system of claim 1, further comprising at least one control device operable to supply power to said at least one monitoring device and said at least one notification device.

9. The hazard notification system of claim 8, wherein said at least one control device is a transceiver.

10. The hazard notification system of claim 8, wherein said at least one activation device is configured to be in wireless communication with said at least one control device.

11. A hazard notification system for monitoring a vehicle travel zone comprising:
at least one monitoring device configured to be connected with a first immobile object;
at least one notification device configured to be connected with a second immobile object and operable to receive information transmitted by said at least one monitoring device;
at least one control device operable to supply power to said at least one monitoring device and said at least one notification device; and
at least one activation device configured to communicate with said at least one control device to enable operation of said at least one monitoring device and said at least notification device before a vehicle embarks through the vehicle travel zone.

12. The hazard notification system of claim 11, wherein the second immobile object is a garage.

13. The hazard notification system of claim 11, wherein said at least one activation device is configured to be in wireless communication with said at least one control device.

14. The hazard notification system of claim 1, wherein said at least one activation device is a motion detector.

15. The hazard notification system of claim 1, wherein said at least one control device is a transceiver.

16. The hazard notification system of claim 1, wherein said at least one notification device is a video display device.

17. The hazard notification system of claim 1, wherein said at least one monitoring device is a camera.

18. A hazard notification system comprising:
at least one monitoring device connected with a garage and configured to gather and relay information relating to hazards in a vehicle travel zone;
at least one notification device connected with said garage and operable to receive said information from said at least one monitoring device;
at least one control device operable to supply power to said at least one monitoring device and said at least one notification device; and
at least one activation device in communication with said at least one control device and operable to cause said control device to enable said at least one notification device and said at least one monitoring device as said vehicle initiates travel rearwardly through said vehicle travel zone.

19. The hazard notification system of claim 18, wherein said at least one notification device is located in front of said vehicle when said vehicle is parked in said garage.

20. The hazard notification system of claim 18, wherein said at least one activation device is a motion detector.

21. The hazard notification system of claim 18, wherein said at least one monitoring device is a camera.

22. The hazard notification system of claim 18, wherein said at least one activation device is in wireless communication with said at least one control device.

23. The hazard notification system of claim 18, wherein said at least one control device is a transceiver.

24. The hazard notification system of claim 23, wherein said transceiver, after being enabled by said at least one activation device, operates for a preselected period of time before automatically shutting down.

25. The hazard notification system of claim 24, wherein said preselected period of time is programmable.

26. The hazard notification system of claim 18, wherein said notification device is a video display device.

27. The hazard notification system of claim 18, wherein said vehicle travel zone is a three dimensional area located proximate to a known location of said vehicle.

28. A hazard notification system comprising:
a means for notifying a driver of hazards in a the vehicle travel zone, wherein said means for notifying is connectable with an immobile structure at least partially surrounding the vehicle travel zone; and
a means for automatically activating said means for notifying before a parked vehicle embarks travels through the vehicle travel zone.

29. A method for detecting hazards in a vehicle travel zone, the method comprising:
operating an activation device;
sending a signal from said activation device to a control device;
enabling a monitoring device and a notification device;
monitoring the vehicle travel zone;
communicating vehicle travel zone information from said monitoring device to said notification device; and
providing notification of said vehicle travel zone information to a driver before embarking through the vehicle travel zone.

30. A method for detecting hazards in a vehicle travel zone, the method comprising:
enabling a monitoring device and a notification device;
monitoring the condition of the vehicle travel zone;
communicating hazards in the vehicle travel zone to a driver; and
deactivating said monitoring device and said notification device upon entry of a vehicle into the vehicle travel zone.

31. A method for detecting hazards in a vehicle travel zone, the method comprising:
activating video monitoring of the vehicle travel zone;
presenting a condition of the vehicle travel zone to a driver; and
deactivating video monitoring of the vehicle travel zone upon the expiration of a time period.
